(19) United States
(12) Patent Application Publication
(10) Pub. No.: US 2026/0278226 A1
(43) Pub. Date: Sep. 17, 2026

(54) METHOD AND AN APPARATUS FOR AN EFFICIENT REPRESENTABLE RANGE CHECKING IN A CHERI RISC-V ENABLED CPU

(71) Applicant: Codasip, s.r.o., Brno (CZ)

(72) Inventors: Tariq Kurd, Bristol (GB); Jamie Ewen Wilkie Melling, Fortrose (GB)

(21) Appl. No.: 19/080,845

(22) Filed: Mar. 15, 2025

(51) Int. Cl. G06F 30/33; G06F 115/10

(52) U.S. Cl. CPC G06F 30/33; G06F 2115/10

(57) ABSTRACT

A method and a system embodying the method for an efficient representable range verification for a CHERI RICS-V enabled CPU, comprising determining MXLEN, MW, and E; determining a relationship between E, MXLEN, and MW; determining whether a delta[MXLEN−1:E+MW] is suitably sign extended for the relationship E+MW<MXLEN; responding to the delta[MXLEN−1:E+MW] being suitably sign extended: determining a cfChange as a difference between a correction factor of the address of the source capability and a correction factor of the address of the destination capability; determining a cin as a carry in from a range [E+MW−1:0]; declaring the representable range verification success for an equation delta[MXLEN-1:E+MW]+cfChange+cin=0 being satisfied; and declaring the representable range verification failure for the equation not being satisfied.

### BACKGROUND

### 1. Field

The present invention relates to processor design. More particularly, this invention is directed towards a method and an apparatus for an efficient representable range checking for a Capability Hardware Enhanced RISC Instructions (CHERI) enabled Central Processing Unit (CPU).

### 2. Description of Related Technology

The design memory safety in the mainstream processors' Central Processing Unit (CPU) is prone to security problems, either via errors in code written in memory-unsafe programming languages such as C and C++ or even in code written in memory-safe programming languages such as Rust, since not all memory safety vulnerabilities can be detected by the compiler. Other security problems stem from exploit attempts, e.g., targeting buffer overruns, Return-oriented-programming (ROP), jump-oriented programming (JOP), and other exploit attempts known to a person of ordinary skill in the art.

A non-CHERI enabled CPU uses integer numbers as pointers, consequently manipulating a pointer is typically accomplished by simple mathematical operations on the pointer and optionally another integer representing an offset. A pointer to any addressable memory to be accessed can be manipulated in any manner, limited only by the programming language or the Instruction Set Architecture. By means of an example the C and C++ languages allow mathematical operations on a pointer to be multiplication by a value, division by a value, subtraction of a value from the pointer, addition of a value to the pointer and other operations known to a person of ordinary skill in the art. Even considering memory-safe programming languages, not all memory safety vulnerabilities can be detected.

Based on the foregoing, a memory address corruption or exploit may happen whenever the program accidentally or maliciously overwrites or overreads a memory to which it should have no access.

Consequently, improvements of memory management became desirable. One such improvement effort resulted in a Capability Hardware Enhanced RISC Instructions (CHERI) project, a joint research project of SRI International and the University of Cambridge, revisiting fundamental design choices in hardware and software to dramatically improve system security. CHERI extends conventional hardware Instruction-Set Architectures (ISAs) with new architectural features to enable fine-grained memory protection and highly scalable software compartmentalization. Although the term CHERI indicates a RISC architecture, the latest standard of which is RISC-V, there is also a version for a Complex Instruction Set Computers (CISC). Therefore, any reference to CHERI extension is meant to indicate both a RISC and a CISC architecture.

The CHERI RISC-V standard supports extra memory security features, most notably via “capabilities”, i.e., bit structures, containing all the information required to identify and authorize access to a region of memory, either virtual or physical, that can help catch flaws such as the above-mentioned errors in a code, buffer overruns, and other memory exploits, before they become security problems. The capabilities' bit structure comprises several fields, e.g., an address field, a value of which represents the pointer, and metadata, i.e., bounds, permissions, and other fields associated with the address field. In addition to the metadata, which can be arbitrarily modified by the software, every capability also has a hardware managed capability validity tag which indicates whether the capability is valid for use, primarily for memory dereferencing.

To manipulate the address field in the capability, unlike the non-CHERI enabled CPU, the CHERI RISC-V standard has defined a limited set of instructions that can manipulate the address field of the capability. Examples of such currently implemented instructions are CADDI-add immediate offset to capability address, CADD-add register offset to capability address, C.ADDI16SP-add scaled signed immediate to stack pointer, C.ADDI4SPN-add scaled unsigned immediate to the stack pointer, SH1ADD, SH2ADD, SH3ADD, SH4ADD-shift and add register offset to capability address, SH1ADD.UW, SH2ADD.UW, SH3ADD.UW, SH4ADD.UW-shift and add register offset to capability address as unsigned words, AUIPC-add immediate offset to the current PC capability, and SCADDR-replace the address field of the capability with a register. The CHERI RISC-V standard may add more such instructions in the future, furthermore an end user can add self-defined instructions. Consequently, any instructions that can manipulate the address field of the capability is contemplated.

The capability comprising an address (referred to as an old address), which is being manipulated by an instruction may be referred to as source capability, the capability comprising an address (referred to as a new address), resulting from such manipulation may be referred to as a destination address, when an absence of such modifier(s) could cause a confusion. When manipulating the address in the address field within a capability by any of the instructions listed above, it is necessary to check that the address field value doesn't violate the rules for the current capability metadata, as a joint encoding scheme is used to define the capability's address and bounds. One such rule defines a representable region comprising an upper and lower limit of addresses within the address field that can be represented without the capability becoming invalid. If a representable region is violated as a result of changing the address within the address field, then the capability validity tag is cleared, and so the capability cannot be used, primarily for dereferencing memory. If the address field falls within the representable region, the destination capability is valid for use, for example the address can be dereferenced by an offset.

As known to a person of ordinary skill in the art, the above-introduced instructions for pointer manipulation are applicable to any memory pointer, e.g., the stack pointer, pointer to a video frame buffer, a pointer to a Universal Asynchronous Receiver/Transmitter (UART), and any other memory pointers.

Consider one of the above-mentioned CHERI RISC-V instructions that accepts a capability as one of its inputs and modifies the address value in the address field. Since the capability is (typically) considered to be a single datatype, i.e., being encoded as a single unit, to access the fields of the capability, the capability must be first decoded. The decoded capability and any other input parameters, if required, are then provided to the CHERI RISC-V instruction, which uses the input parameters to calculate a new address value. Before the capability can be provided for further processing or storage, a plurality of tests required by the pointer manipulation instructions verifying, e.g., whether bounds are malformed, whether reserved bits are set, whether the capability is sealed, whether the new address remains within the representable range, are performed. Failure of any of these tests results in the capability verification tag, if previously set, being cleared. All the tests except the representable range test are computationally trivial; consequently, the representable range verification, is the subject-matter of this invention. Therefore, it is assumed that the source capability verification tag is set, the bounds are not malformed, no reserved bits are set, and the capability is unsealed.

As implemented in the CHERI RISC-V standard (current version 0.9.5), incorporated herein by reference, all the tests must be performed before the capability containing the new address and the correct value of the capability verification tag, is encoded and forwarded, i.e., presented for correct use as an input parameter of another instruction. The capability verification tag is said to be propagated in case that the representable range verification succeeds, or cleared in case that the representable check fails.

As specified in the above-mentioned CHERI RISC-V standard, in particular chapter 3.4. Representable Range Check, the representable range verification passes if the top and base bound of source and destination capabilities have the same values, cf., Eq. (1):

$$oldTopBound [ MXLEN : 0 ] == newTopBound [ MXLEN : 0 ] \&\& \qquad ( 1 )$$

$$oldBaseBound [ MXLEN - 1 : 0 ] == newBaseBound [ MXLEN - 1 : 0 ]$$

wherein:
oldTopBound[MXLEN:0] is the top bound decoded from the source capability;
newTopBound[MXLEN:0] is the top bound decoded from the destination capability;
oldBaseBound[MXLEN−1:0] is the base bound decoded from the source capability;
newBaseBound[MXLEN−1:0] is the base bound decoded from the destination capability.

According to the CHERI RISC-V standard, a mismatch between oldTopBound[MXLEN:0] and newTopBound[MXLEN:0] implies a mismatch between oldBaseBound[MXLEN−1:0] and newBaseBound[MXLEN−1:0]. Therefore, Eq. (1) can be replaced by either Eq. (2) or Eq. (3).

$$oldTopBound [ MXLEN : 0 ] == newTopBound [ MXLEN : 0 ] \qquad ( 2 )$$

$$oldBaseBound [ MXLEN - 1 : 0 ] == newBaseBound [ MXLEN - 1 : 0 ] \qquad ( 3 )$$

In that regard, the CHERI RISC-V standard recommends solving Eq. (2), and requires a simpler form excluding the top bit, resulting in Eq. (4):

$$oldTopBound [ MXLEN - 1 : 0 ] == newTopBound [ MXLEN - 1 : 0 ] \qquad ( 4 )$$

When calculating the oldTopBound[MXLEN−1:0] and the newTopBound[MXLEN−1:0], the CHERI RISC-V standard specifies a portion of the address field to be used depending on the value of E as summarized in Table 1. Note that the second row is a degenerate case of row one, i.e., the range is [MW, MXLEN−1] and the lower section of the Top Bound doesn't exist.

TABLE 1

| | Upper Section | Middle Section | Lower Section |
|---|---|---|---|
| | of the Top | of the Top | of the Top |
| Condition | Bound | Bound | Bound |
| E + MW < | addr[MXLEN-1: | T[MW-1: 0] | {E{1′b0}} |
| MXLEN, | E + MW] + ct | | |
| E > 0 | | | |
| E = 0 | addr[MXLEN-1: | T[MW-1:0] | N/A |
| | MW] + ct | | |

Wherein:
addr—address associated with the capability;
MXLEN—constant maximum length of the address, i.e., either 64 bits or 32 bits;
E—exponent parameter in the range of [0, 52] bits for a 64-bit system and [0, 24] bits for a 32-bit system;
MW—constant mantissa width, i.e., 14 bits for a 64-bit system and 10 bits for a 32-bit system;
ct—correction factor for the top address bound calculation associated with the capability;
T—a value extracted from the capability metadata used to calculate the middle section of the top bound.

The values T and E are the same for both the source and the destination capability; only the values of addr [MXLEN−1:E+MW] and ct can vary. Therefore, only the upper section of the Top Bound needs to be recalculated, consequently Eq. (4) assumes the following form:

$$new Addr [ MXLEN - 1 : E + MW ] + new Ct == old Addr [ MXLEN - 1 : E + MW ] + old Ct \qquad ( 5 )$$

wherein:
newAddr—new address, i.e., the updated old address;
newCt—correction factor for the top address bound calculation associated with the new address;
oldAddr—old address, i.e., the address before the address update; and
oldCt—correction factor for the top address calculation associated with the old address.

The specific address range, i.e., the expression within the square brackets, e.g., [X:Y], is interpreted as the bits between the indices X and Y.

The CHERI RISC-V standard provides an alternative to calculate correction factor for the bottom bound of the address. The inventors noted that this can be used to reformulate Eq. (5) to Eq. (5a):

$$newAddr [ MXLEN - 1 : E + MW ] + newCb == oldAddr [ MXLEN - 1 : E + MW ] + oldCb \qquad ( 5 a )$$

wherein:
newCb—correction factor for the base address bound calculation associated with the new address;
oldCb—correction factor for the base address calculation associated with the old address.

The equations differ in that the correction factors newCt/oldCt or newCb/oldCb are used respectively which are calculated over the same range. Since either the ct or cb may be used, for the purposes of this application a variable cf (correction factor) is used, and examples of its calculation is provided infra. Based on the comparison of Eq. (5) to Eq. (5a), a person of ordinary skill in the art understands that one of the two alternative means of calculation must be used, i.e., the newCf and oldCf must be calculated using the formula for the newCt and oldCt or the formula for the newCb and oldCb.

Operations associated with solving the Eq. (5)/(5a) in the prior art take time because calculating the elements of Eq. (5)/(5a) requires that the Arithmetic Logical Unit (ALU) of the Central Processing Unit (CPU) of the processor determines newAddr[MXLEN−1:0]. The CHERI RISC-V standard specifies that for E>0, the bits for newAddr[MXLEN−1:MW] and the oldAddr[MXLEN−1:MW], are set to 0 for the range [MW, E+MW−1]; for E=0 the bits in the bits for newAddr[MXLEN−1:MW] and oldAddr[MXLEN−1:MW] remain unchanged. Such newAddr[MXLEN−1:MW] and oldAddr[MXLEN−1:MW] are then operated on by an additional almost full-width subtractor, i.e., 50-bits for 64-bit system and 22-bits for a 32-bit system, which calculates newAddr[MXLEN−1:MW]-oldAddr[MXLEN−1:MW]. The change in cf values is detected by a pair of MW-bit wide comparators, i.e. 14-bits for a 64-bit system and 10-bits for a 32-bit system, which compare newAddr[E+MW−1:E] and oldAddr[E+MW−1:E] against R[MW−1:0], which is calculated from the capability metadata. The cf values are then subtracted to find the difference and shifted left by E. The subtraction of the addresses is followed by a wide comparator, i.e., 50-bits for 64-bit system and 22-bits for a 32-bit system, which compares the change in addresses with the change in cf values.

Depending on the clock frequency of the CPU, the above-described operations required for evaluation of Eq. (5)/(5a) may not be accomplished within a single clock cycle, due to the additional subtractor and the comparator needing to be performed as sequential operations following the ALU operation. The ALU operation, setting the bits in the addresses' range, and the additional operations requiring either reduction of the clock frequency of the central processing unit (CPU) to extend the clock cycle or an addition of an extra clock cycle before forwarding the destination capability. Consequently, this representable range verification, slows the basic operations of pointer increments and any subsequent instruction(s) using the result of the destination capability as an input. Since slowdown of basic operations of pointer increments has a strong negative impact on the performance of the CHERI enabled CPU, there is a need in the art for faster representable range verification calculations, enabling forwarding the correct value of the tag for CHERI memory pointer increments.

Based on the foregoing, there is a need to provide a solution to the above identified problem of efficient representable range verification, as well as additional advantages.

### SUMMARY

In an aspect of the disclosure, an apparatus and a method for an efficient representable range checking for a CHERI RISC-V enabled CPU according to appended independent claims is disclosed. Additional aspects are disclosed in the dependent claims.

### BRIEF DESCRIPTION OF THE DRAWINGS

The foregoing aspects described herein will become more readily apparent by reference to the following description when taken in conjunction with the accompanying drawings wherein:

FIG. 1 depicts a conceptual structure and information flow among entities implementing an efficient representable range checking for a CHERI enabled CPU in accordance with the invention; and

FIG. 2 depicts a conceptual structure of a 64-bit serial adder for a 64-bit system.

### DETAILED DESCRIPTION

Unless otherwise defined, all terms (including technical and scientific terms) used herein have the same meaning as commonly understood by a person having ordinary skill in the art to which this invention belongs. It will be further understood that terms, such as those defined in commonly used dictionaries, should be interpreted as having a meaning that is consistent with their meaning in the context of the relevant art and this disclosure.

As used herein, the singular forms “a,” “an,” and “the” are intended to include the plural forms as well, unless the context clearly indicates otherwise. It will be further understood that the terms “comprise,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof. The term “and/or” includes any and all combinations of one or more of the associated listed items.

Various disclosed aspects may be illustrated with reference to one or more exemplary configurations. As used herein, the term “exemplary” means “serving as an example, instance, or illustration,” and should not necessarily be construed as preferred or advantageous over other configurations disclosed herein.

Various aspects of the present invention will be described herein with reference to drawings that are schematic illustrations of conceptual configurations of the present invention, unless explicitly noted. The various aspects of this disclosure are provided to enable a person having ordinary skill in the art to practice the present invention. Modifications to various aspects presented throughout this disclosure will be readily apparent to a person having ordinary skill in the art, and the concepts disclosed herein may be extended to other applications.

When considering alternative solution to Eq. (5)/(5a), the inventors observed that given the ranges of MXLEN, MW and E, for E+MW≥MXLEN, the Upper Section of the Top Bound does not exist. This situation is summarized in Table 2:

TABLE 2

| | Upper Section | Middle Section | Lower Section |
|---|---|---|---|
| | of the Top | of the Top | of the Top |
| Condition | Bound | Bound | Bound |
| E + MW ≥ | N/A | T | {E{1′b0}} |
| MXLEN | | [MXLEN-E-1:0] | |

Since, as defined by the CHERI RISC-V standard, the only bit range of addresses of the source and destination capabilities that can affect the representability verification is [E+MW, MXLEN−1], for E+MW≥MXLEN, it follows that Eqs. (1)-(4) are always satisfied; consequently, there is no need to consider solving Eq. (5)/(5a). For all other cases Eq. (5)/(5a) must be solved.

To consider more efficient evaluation of Eq. (5)/(5a), defined over the range [E+MW, MXLEN−1], it is understood that the new address needs to be evaluated over the entire range:

$$newAddr [ MXLEN - 1 : 0 ] = oldAddr [ MXLEN - 1 : 0 ] + delta [ MXLEN - 1 : 0 ] \qquad ( 6 )$$

The range [E+MW, MXLEN−1], can be affected by a potential carry bit cin from the range [0, E+MW−1] due to the summation on the right-hand side of Eq. 6.

To avoid the need for the wide subtractor and the comparator, and consequently the additional time associated with their operation, Eq. (6) can be formally rewritten over the range [E+MW, MXLEN−1], cin being defined over a different range, yielding:

$$newAddr [ MXLEN - 1 : E + MW ] = oldAddr [ MXLEN - 1 : E + MW ] + delta [ MXLEN - 1 : E + MW ] + cin \qquad ( 7 )$$

wherein the carry bit cin is calculated as:

$$cin = ( oldAddr [ E + MW - 1 : 0 ] + delta [ E + MW - 1 : 0 ] ) ≫ ( E + MW ) \qquad ( 8 )$$

Substituting Eq. (7) into equation (5)/(5a) and using the correction factor cf as disclosed supra, yields:

$$oldAddr [ MXLEN - 1 : E + MW ] + delta [ MXLEN - 1 : E + MW ] + newCf + cin = oldAddr [ MXLEN - 1 : E + MW ] + oldCf \qquad ( 9 )$$

Which can be further simplified to:

$$delta [ MXLEN - 1 : E + MW ] + new Cf - old Cf + cin = 0 \qquad ( 10 )$$

and to an alternative form:

$$delta [ MXLEN - 1 : E + MW ] + cf Change + cin = 0 \qquad ( 11 )$$

Regarding Eq. (11) as disclosed regarding Table 2, for the condition E+MW≥MXLEN Eq. (11) does not need to be evaluated since Eq. (1) is always satisfied and the representable range verification thus passes.

As shown in detail below, restatement of the representable range verification in terms of Eq. (11) avoids the necessity for the additional subtractor and potentially a comparator, which are contributing to the inefficiency of evaluation Eq. (5)/(5a).

The value of delta[MXLEN−1:E+MW] is either immediately available as a parameter, cf. Eq. (6), or in case of a CHERI RISC-V instruction, e.g., SHnADD, the value of delta[MXLEN−1:E+MW] is obtained by an efficient calculation. Consequently, even in the worst case timing scenario, e.g., in the case of a CHERI RISC-V instruction being SCADDR, delta[MXLEN−1:E+MW] is available no later than the newAddr[MXLEN−1:0].

The determination of the value cf Change is performed by the same structures and methods as disclosed in the CHERI RISC-V standard; therefore, requiring the same time.

The determination of the value of cin, is performed by the inventive methods avoiding the need to solve Eq. (8). Furthermore, regardless of the inventive method employed, the determination of cin can be performed in parallel with the determination of cfChange.

The representable range verification can be further simplified by not solving Eq. (11). As will be shown in details infra, parameters of Eq. (11) are either, or can be reduced to, a single bit-length or at least two bit-length, such parameters being restricted to limited number of input states. This thus avoids the additional almost full width subtractor and potentially a comparator with a reduced number of bits.

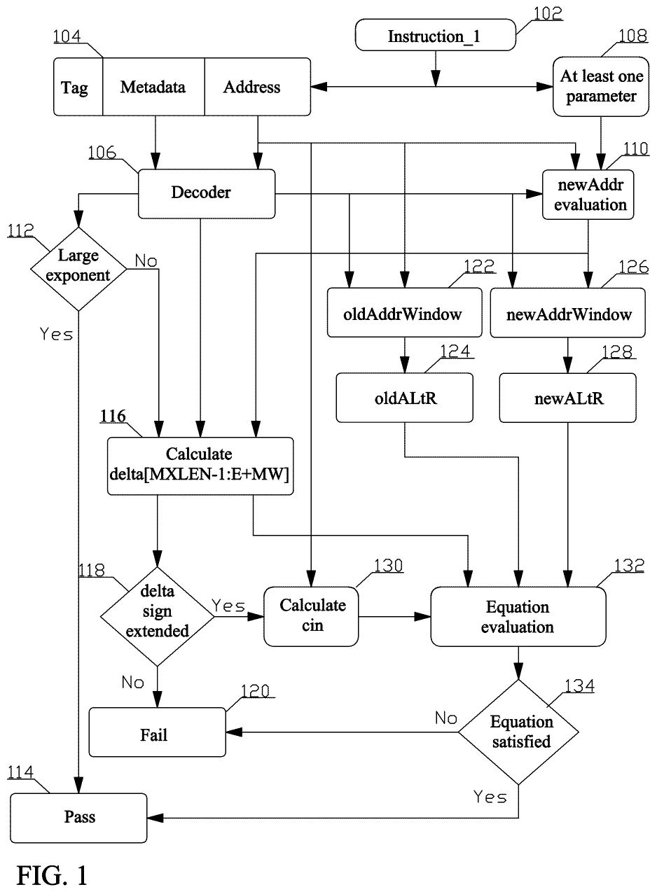

FIG. 1 depicts a conceptual structure and information flow among entities implementing an efficient representable range checking for a CHERI RISC-V enabled CPU in accordance with the invention.

A CHERI instruction 102 that accepts a capability as one of its inputs and modifies the address in the address field that requires verification, is fetched from a pipeline (not shown). The CHERI instruction 102 caused the CPU to request a source capability 104 stored in a register, to be used as one of the instruction's 102 input parameters, together with at least one parameter 108, likewise stored in a register or within the instruction. Some CHERI instruction(s) 102, accept an address of the destination capability, hereinafter denoted as newAddr[MXLEN−1:0], as a parameter; in such a case the at least one parameter 108 is calculated as the difference between the newAddr[MXLEN−1:0] and an address of the source capability, hereinafter denoted as oldAddr[MXLEN−1:0]. For some instructions, the parameter(s) comprising the at least one parameter 108 is/are resulting from executing instruction(s) preceding the instruction 102, for some specific instruction, e.g., CADDI, the at least one parameter 108 is generated by another entity, e.g., a compiler, and inserted into the structure comprising the instruction.

For other CHERI instructions 102, the at least one parameter 108 comprises value/values of delta[X:Y], to be summed with the address of the source capability 104 oldAddr[MXLEN−1:0], to yield the newAddr[MXLEN−1:0]. As indicated by the range [Y, X], the at least one parameter 108 may not be of the same range as the addresses of the source and destination capability, i.e., [0, MXLEN−1]. Consequently, the range of the at least one parameter 108 must be adjusted to match this range, i.e., to be sign extended or zero extended if the at least one parameter's 108 range is smaller than [0, MXLEN−1], and to be truncated if the at least one parameter's 108 range is larger than [0, MXLEN−1]. The operation(s) of sign extension, zero extension or truncation may be required for any operation between operands of different ranges, e.g., as discussed herein between the addresses of the source and destination capabilities with a range [0, MXLEN−1] and the at least one parameter 108 with a range different from the [0, MXLEN−1], or where an operation on the at least one parameter 108 results in a range different than [0, MXLEN−1]. The range adjustment is performed by any hardware entity capable of adjusting the range, e.g., a bit copying logic for the sign extension or the zero extension and a logic discarding bits for the truncation, or a software entity capable of adjusting the range.

Table 3 summarizes the possible relationships between the oldAddr[MXLEN−1:0], the newAddr[MXLEN−1:0], and the delta[MXLEN−1:0], as defined by the CHERI RISC-V standard.

TABLE 3

| | oldAddr | newAddr | delta |
|---|---|---|---|
| | [MXLEN-1:0] | [MXLEN-1:0] | [MXLEN-1:0] |
| CADD | cs1.address | cs1.address + rs2 | rs2 |
| CADDI | cs1.address | cs1.address + | signExtendToMXLENBits |
| | | signExtendToMXLENB | (imm[11:0]) |
| | | its (imm[11:0]) | |
| SHnADD | cs2.address | truncateToMXLENBit | truncateToMXLENBits |
| n = 1, 2, 3, 4 | | s (rs1 << n) + | (rsl << n) |
| | | cs2.address | |
| SCADDR | cs1.address | rs2 | rs2-cs1.address |
| C.ADDI16SP | csp.address | csp.address + | SignExtendTOMXLENBits |
| | | SignExtendTOMXLENB | ({nzimm[9:4], 4′b0}) |
| | | its ({nzimm[9:4], | |
| | | 4′b0}) | |
| C.ADDI4SPN | csp.address | csp.address + | SignExtendTOMXLENBits |
| | | SignExtendToMXLENB | ({1′b0, nzuimm[9:3] , |
| | | its ({1′b0, nzuimm[9:3], | 3′b0}) |
| | | 3′b0}) | |

Should the at least one parameter 108 comprise more than one parameter, the newAddr[MXLEN−1:0], is calculated by successive addition or a shift and an addition of the oldAddr[MXLEN−1:0] and the parameters adjusted to the range [0, MXLEN−1], alternatively the parameters adjusted to the range [0, MXLEN−1] are added or shifted and added before calculating the newAddr[MXLEN−1:0].

The source capability's 104 address and metadata are provided to a decoder 106. The decoder 106 uses the metadata to decode E a variable exponent, B a value substituted into the capability's address to decode the base address bound, T a value substituted into the capability's address to decode the top address bound. The positions, at which B and T are substituted into the capability's address is determined from the variable exponent E, a maximum value of which (CAP_MAX_E) is known from the system design. Since the system design determines the bit-width of the data, and the maximum bit-width of memory addresses, e.g., 64 bits or 32 bits, the values of MXLEN and a mantissa of width MW bits are known from the hardware embodiment of the CHERI RISC-V enabled CPU.

Analyzing Eq. (11), as disclosed supra, for the condition E+MW≥MXLEN Eq. (11) does not need to be evaluated since Eq. (1) is always satisfied. The condition E+MW≥MXLEN, may be restated as:

$$new Addr [ MXLEN - 1 : E + MW ] + new Ct == old Addr [ MXLEN - 1 : E + MW ] + old Ct \qquad ( 12 )$$

wherein CAP_MAX_E is maximum legal value for E, i.e., 52 for MXLEN=64 and 24 for MXLEN=32, the exponent can be termed a large exponent, Eq. (1) is always satisfied, and the representable verification succeeds. Consequently, determining whether the condition E+MW≥MXLEN is satisfied, can be replaced with determining whether E is a large exponent. The term “legal” is meant to exclude the possibility of E>52 for MXLEN=64 and E>24 for MXLEN=32 in the case that the capability is malformed due to hardware or software failure. Such a malformed capability is identified with a cleared tag. Regardless of whether the condition or the E is being determined, such a determination is performed by any hardware entity capable of evaluating the inequality, e.g., an adder and a comparator, or a software entity capable of evaluating the inequality.

This observation has been being submitted to be included in the future version of the CHERI RISC-V standard, which will clarify that for E>(CAP_MAX_E−3) the representability check always succeeds.

Block 110's evaluation of the newAddr[MXLEN−1:0] depends on the CHERI instruction 102. Should the CHERI instruction 102 accept newAddr[MXLEN−1:0] as the at least one parameter 108, the newAddr[MXLEN−1:0] is passed by block 110 for further processing to block 116, which calculates delta[MXLEN−1:0] as the difference between the newAddr[MXLEN−1:0] and the oldAddr[MXLEN−1:0]. Block 116 represents any hardware entity capable of evaluating the subtraction, e.g., an adder or subtractor, or a software entity capable of evaluating the difference.

For the other CHERI instructions 102, the oldAddr[MXLEN−1:0] from the source capability 104 and the at least one parameter 108 requested by the CPU from the register or the instruction, are provided to block 110, which calculates the newAddr[MXLEN−1:0]. In one aspect of the invention, block 110 comprises an ALU, a part of the Central Processor Unit (not shown), in another aspect of the invention, block 110 represents any hardware entity capable of evaluating the difference, e.g., an adder or subtractor, or a software entity capable of evaluating the difference. Should the at least one parameter 108 comprise two or more parameters, the newAddr[MXLEN−1:0] is calculated by successive addition or shift and addition operations on the oldAddr[MXLEN−1:0] and the parameters, or the parameters are combined before calculating the newAddr[MXLEN−1:0], including the potential need for sign extension, zero extension and truncation as described supra. The at least one parameter 108 is then passed to block 116, which uses at least one parameter 108 to calculate delta[MXLEN−1:0], and adjusts the range from delta[MXLEN−1:0] to the range delta[MXLEN−1:E+MW].

Examining Eq. (11), the inventors observed that the expressions in Eq. (11) evaluate to a limited set of values. Considering that cin potentially represents a carry bit, cin can only be one of [0, 1]. Similarly, per the CHERI RISC-V standard the cfChange can only be one of [0,−1, 1]. As further disclosed in paragraphs [67]-[70], certain combinations of cin and cfChange are logically impossible. The term “logically” is understood as meaning that such a combination cannot occur in the absence of a hardware or software failure. Consequently, the sum of cin and cfChange can only be a value of 0 or 1, and Eq. (11) can only be satisfied if delta[MXLEN−1:E+MW]=0 or delta[MXLEN−1:E+MW]=−1. For delta[MXLEN−1:E+MW]=0, all the bits in the range [E+MW, MXLEN−1] must be 0. For delta[MXLEN−1:E+MW]=−1, all the bits in the range [E+MW, MXLEN−1] must be 1 because then the value of delta[MXLEN-1:E+MW] is representing the upper bits of a negative number encoded using two's complement signed arithmetic. In the two instances of delta[MXLEN−1:E+MW] being either all 0's and delta[MXLEN−1:E+MW] being either all 1's, then delta[MXLEN−1:E+MW] is for this document said to be suitably sign extended.

Based on the foregoing observation, the result of the calculation of block 116 is provided to decision block 118, which evaluates whether delta[MXLEN−1:E+MW] is or is not suitably sign extended. Block 118 may comprise by any hardware entity capable of determining, whether delta[MXLEN−1:E+MW] comprises all 0s or all 1s, e.g., hardware AND reduction and hardware OR reduction accepting the bits of the range [E+MW, MXLEN−1] as inputs and the outputs of which are combined to indicate whether the bits are the same or not, or a software entity capable of evaluating whether the bits are the same or not, The evaluation always succeeds if it is known that the value of delta[MXLEN−1:0] is sufficiently small, if the E+MW value is sufficiently large, if the instruction 102 is a specific instruction, or in combinations of any of these three cases, as explained below.

Consider the case of delta[MXLEN−1:0], wherein the maximum range of values that the delta[MXLEN−1:0] may attain is [−2^{E+MW-1}, +2^{E+MW-1}−1]. Then it is guaranteed that all the bits of delta[MXLEN−1:E+MW] will have the same value; therefore, delta[MXLEN−1:0] is suitably sign extended, and the evaluation of block 118 succeeds. Consider additionally that E=0, wherein the maximum range of values further simplifies to [−2^{MW-1}, +2^{MW-1}−1]. Thus, it is again guaranteed that all the bits of delta[MXLEN−1:MW] will have the same value; therefore, delta[MXLEN−1:E+MW] is suitably sign extended and the evaluation in block 118 succeeds. Both of these will succeed regardless of whether the system is 64-bit, i.e. MXLEN=64 or 32-bit, i.e., MXLEN=32, or any possible future bit system size, to be reflected by the value of MXLEN. Based on the foregoing, the suitably sign extended check succeeds for the maximum range of values [−2^{N}, +2^{N}−1], wherein the maximum value of N being the number of bits of delta[E+MW−1:0]−1, and the condition E+MW>N is satisfied.

Specifically for a 64-bit system, for which MW=14, for delta[E+MW−1:0] the value of N=13, therefore, the maximum range of values that the delta[MXLEN−1:0] can attain is [−2^{13+E}, +2^{13+E}−1]. Consequently, it is guaranteed that all bits of delta[MXLEN−1:E+MW] will have the same value; therefore, delta[MXLEN−1:E+MW] is always suitably sign extended for any value of E, and the evaluation of block 118 succeeds.

Similarly for a 32-bit system, for which MW=10, for delta[E+MW−1:0] the value of N=9, therefore, the maximum range of values delta[E+MW−1:0] can attain is [−2^{9+E} to +2^{9+E}−1]. Consequently, it is guaranteed that all bits of delta[MXLEN−1:E+MW] will have the same value; therefore, delta[MXLEN−1:E+MW] is always suitably sign extended for any value of E, and the evaluation of block 118 succeeds.

The CHERI RISC-V standard defines specific instructions for which the value of delta[MXLEN−1:0] lies within a limited range. By means of an example, the instruction CADDI specifies that the Most Significant Bit (MSB) of the least one parameter 108 which results in delta[MXLEN−1:0], is copied to positions [12, MXLEN−1], therefore the parameter is sign extended from 12-bits to MXLEN bits. Since for a 64-bit system MW=14, for delta[E+MW−1:0] the value of N=11, therefore, the maximum inclusive range that delta[E+MW−1:0] can attain is [−2¹¹, +2¹¹−1]. Referring to paragraph [51] supra, the evaluation of block 118 succeeds.

However, for a CADDI instruction in a 32-bit system MW=10, for delta[E+MW−1:0], N=9, therefore, the range of values delta[E+MW−1:0] can attain is [−2^{9+E} to +2^{9+E}−1]. Consequently, it is guaranteed that all bits of delta[MXLEN−1:E+MW] will have the same value if and only if E>1 to satisfy the condition E+MW>N. Referring to paragraph [51] supra, for such a value of E the evaluation of block 118 succeeds.

The CADDI instruction's at least one parameter 108 is typically a small value that is likely to succeed the test for a 32-bit system even for E=0, wherein the range of values delta[E+MW−1:0] can attain is [−2⁹ to +2⁹−1], the evaluation in block 118 may be altered to test whether the three most significant bits (MSB) of delta[11:9] all have the same values and if so, the evaluation succeeds. For E=1, wherein the range of values delta[E+MW−1:0] can attain is [−2¹⁰ to +2¹⁰−1], the evaluation in block 118 may be altered to test whether the two MSBs of delta[11:10] both have the same values and if so, the evaluation succeeds.

By means of other examples of specific instructions are C.ADDI16SP and C.ADDI4SPN. By definition of these instructions as represented in Table 3, for the C.ADDI16SP the values delta[E+MW−1:0] can attain is [−2⁸, 2⁸−1], for the C.ADDI4SPN the value delta[E+MW−1:0] can attain is [0, 2⁹−1]. Consequently, both instructions are always suitably sign extended, and the evaluation of block 118 succeeds for both the 64-bit and 32-bit systems.

If the evaluation in block 118 evaluates the delta[MXLEN−1:E+MW] as not suitably sign extended, the decision means that Eq. (11) cannot be satisfied, the representable verification fails and any further evaluation of Eq. (11) is unnecessary. The failure of the representable verification is indicated by clearing the capability verification tag by block 120. Block 120 thus represents a hardware entity setting the verification tag as specified by the CHERI RISC-V standard. If decision block 118 evaluates the delta[MXLEN−1:E+MW] as suitably sign extended, then Eq. (11) must be solved.

In one aspect of the invention, Eq. (11) is solved by direct computation. The disadvantage of this aspect is computationally expensive resulting in increased computation time because such computation requires computation of cfChange and cin, where computation of cin requires using a structure comprising multiple adders because E is variable, or other structures known to a person of ordinary skill in the art.

In another aspect of the invention, Eq. (11) is solved by exploiting the fact, that as the inventors further observed,

To calculate the cfChange, from Eq. (10) and Eq. (11) cfChange=newCf−oldCf, consequently, the correction factors newCf and oldCf must be calculated. The CHERI RISC-V standard defines that a correction factor cf is calculated by taking an address slice or a window of an address:

$$addr Window [ MW - 1 : 0 ] = addr [ E + MW - 1 : E ] \qquad ( 13 )$$

calculating R[MW−1:0], i.e., the representable range limit:

$$R [ MW - 1 : 0 ] = B [ MW - 1 : 0 ] - {2}^{\hat{}} ( MW - 2 ) \qquad ( 14 )$$

and using Table 4 to determine cf, requiring a two-bit arithmetic using standard 2's complement notation:

TABLE 4

| | T [MW-1:0] < | |
|---|---|---|
| addrWindow | R [MW-1:0] or | |
| [MW-1:0] < | B [MW-1:0] < | |
| R[MW-1:0] | R [MW-1:0] | cf |
| 0 | 0 | 0 |
| 0 | 1 | +1 |
| 1 | 0 | −1 |
| 1 | 1 | 0 |

In one aspect of the invention, Table 4 can be used to first calculate the oldCf from oldAddrWindow[MW−1:0] and newCf from newAddrWindow[MW−1:0], and then calculate cfChange=newCf−oldCf. As described in the discussion regarding Eq. (5)/(5a), either the comparison T [MW−1:0]<R[MW−1:0] or the comparison B [MW−1:0] <R[MW−1:0] is used. The calculation is performed by any hardware entity capable of evaluating the inequalities of Table 4 to determine the newCf and the oldCf followed by evaluating the difference, e.g., at least an adder and at least one comparator, or a software entity capable of evaluating the inequalities and the difference.

Calculation of cfChange can be further simplified. To calculate the oldCf, an address slice of the old address:

$$old Addr Window [ MW - 1 : 0 ] = old Addr [ E + MW - 1 : E ] \qquad ( 15 )$$

calculated in block 122 and then compares the result against the representable limit R

$$old ALtR = old Addr Window [ MW - 1 : 0 ] < R [ MW - 1 : 0 ] \qquad ( 16 )$$

in block 124, wherein ALtR is shorthand for addrWindow<R[MW−1:0].

Similarly, to calculate the newCf, equations similar to Eq. (15) and Eq. (16) can be formulated for the newAddr:

$$new Addr Window [ MW - 1 : 0 ] = new Addr [ E + MW - 1 : E ] \qquad ( 17 )$$

which is calculated in block 126 and then compares the result against the representable range limit R:

$$new ALtR = new Addr Window [ MW - 1 : 0 ] < R [ MW - 1 : 0 ] \qquad ( 18 )$$

in block 128.

The operations described by Equations (15), (16), (17), and (18) result in the newALtR and the oldALER being a single bit. Considering that per Table 4, T [MW−1:0]<R[MW−1:0] or B [MW−1:0]<R[MW−1:0] are used for the calculation of cf and are constant for both the source and the destination capabilities, the change between the newCf and the oldCf, i.e., cfChange can be inferred by only calculating newALtR and oldALER as shown in Table 5, i.e., cfChange=newCf−oldCf=oldALtR−newALtR. Since Table 4 was used to construct Table 5, it follows that calculation of oldALER−newALtR requires at least two-bit arithmetic using standard 2's complement notation as noted in discussion regarding Table 4.

TABLE 5

| newCf-oldCf | oldALER | newALtR |
|---|---|---|
| 0 | 0 | 0 |
| +1 | 1 | 0 |
| −1 | 0 | 1 |
| 0 | 1 | 1 |

Considering Table 4 and Table 5, certain combinations of cin and cfChange, namely cin=0 and cfChange=−1, cin=1 and cfChange=1 are logically impossible. The term “logically” is meant to meant to exclude the possibility such a combination due to hardware or software failure.

Consider that newALtR is 1 and oldALER is 0, from Table 5 cfChange=−1. Based on Eq. (17) and Eq. (18) it follows that newAddrWindow<oldAddrWindow, which can only be satisfied if there was a carry out of the newAddrWindow resulting in cin=1. Consequently, the combination of cfChange=−1 and cin=0 is logically impossible.

Similarly, if newALtR is 0 and oldALtR is 1, from Table 5 cfChange=+1. Based on Eq. (15) and Eq. (16) it follows that newAddrWindow>oldAddrWindow, which can only be satisfied if there was a not a carry out of the newAddrWindow resulting in cin=0. Consequently, the combination of cfChange=+1 and cin=1 is logically impossible.

Based on the foregoing, cfChange can only have values [1,−1, 0] and cin can have values [0, 1], with the combinations cin=0 and cfChange=−1, cin=1 and cfChange=1, being logically impossible. Therefore, the only logically possible summation of cin and cfChange is either 0 or 1.

The value of cin is computed in block 130. In one aspect of the invention, computational efficiency of block 130 can be achieved by avoiding solving Eq. (8) directly, i.e., calculating the operands comprising the equation, and substituting the operands into the equation. Consider a one-bit full adder truth table as presented below as Table 6. This truth table holds for any inputs A, B, carry in, and output sum (A, B) and carry out. Thus, the table can be applied to the calculation already performed by Eq. (6), wherein A=oldAddr[Z], B=delta[Z], newAddr[Z]=sum (oldAddr[Z], delta[Z]), wherein Z is at index E+MW bounded by at least the range [MW, MXLEN−1]. In addition, Table 6 also shows the values of carry_in[Z] and carry_out[Z] produced by the full adder, but not necessarily exposed externally.

TABLE 6

| carry_in[Z] | oldAddr[Z] | delta[Z] | newAddr[Z] | carry_out[Z] |
|---|---|---|---|---|
| 0 | 0 | 0 | 0 | 0 |
| 0 | 0 | 1 | 1 | 0 |
| 0 | 1 | 0 | 1 | 0 |
| 0 | 1 | 1 | 0 | 1 |
| 1 | 0 | 0 | 1 | 0 |
| 1 | 0 | 1 | 0 | 1 |
| 1 | 1 | 0 | 0 | 1 |
| 1 | 1 | 1 | 1 | 1 |

Analyzing Table 6, it can be observed, that carry_in[Z] value is 1 when the number of 1's in oldAddr[Z], delta[Z], and newAddr[Z] is odd, and carry_in[Z] value is 0 when the number of 1's in oldAddr[Z], delta[Z], and newAddr[Z] is even. This observation implies that a 3-input XOR gate can be used to calculate the carry_in[Z], using the oldAddr[Z], delta[Z], and newAddr[Z] as inputs. The cin is equal to carry_in[Z], a calculation of which is expressed by the following equation:

$$carry\_in [ Z ] = new Addr [ Z ] XOR old Addr [ Z ] XOR delta [ Z ] \qquad ( 18 )$$

The calculation may be performed by any hardware entity capable of evaluating the equation, e.g., comprising bit-wise XOR accepting as an input newAddr[Z], oldAddr[Z], and delta[Z], and providing the carry_in[Z] as an output, or a software entity capable of evaluating the equation.

Alternatively, the calculation of carry_in can be performed for each index in at least the range [MW, MXLEN−1] using the XOR gates can be done in parallel, as expressed by the following equation:

$$carry\_in [ MXLEN - 1 : MW ] = new Addr [ MXLEN - 1 : MW ] XOR old Addr [ MXLEN - 1 : MW ] XOR delta [ MXLEN - 1 : MW ] \qquad ( 19 )$$

and once such calculation is performed, the specific bit of carry_in[MXLEN−1:MW] is selected as the cin at index E+MW, cf., Eq. (11).

The calculation may be performed by any hardware entity capable of evaluating the equation, e.g., comprising a plurality of bit-wise XORs, each of the XORs accepting as an input newAddr[MXLEN−1:MW], oldAddr[MXLEN−1:MW], and delta[MXLEN−1:MW] for a different index from the range [MW, MXLEN−1], and providing on each of the XOR the carry_in[MXLEN−1:MW] for that index, followed by a multiplexer accepting the outputs and selecting the cin, or a software entity capable of evaluating the equation.

Referring to Table 6, a person of ordinary skill in the art will understand that instead of calculating carry_in[Z], a carry_out[Z] equal to the cin, where Z is index E+MW−1 instead, can be calculated by the following equation:

$$carry\_out [ Z ] = ( ( old Addr [ Z ] XOR delta [ Z ] ) AND NOT ( new Addr [ Z ] ) ) OR ( old Addr [ Z ] AND delta [ Z ] ) \qquad ( 20 )$$

Alternatively, the calculation of carry_out can be performed for each index in at least the range [MW−1, MXLEN−2] can be done in parallel, as expressed by the following equation:

$$carry\_out [ MXLEN - 2 : MW - 1 ] = ( ( old Addr [ MXLEN - 2 : MW - 1 ] XOR delta [ MXLEN - 2 : MW - 1 ] ) AND NOT ( new Addr [ MXLEN - 2 : MW - 1 ] ) ) OR ( old Addr [ MXLEN - 2 : MW - 1 ] AND delta [ MXLEN - 2 : MW - 1 ] ) \qquad ( 21 )$$

and once such calculation is performed, the specific bit of carry_out[MXLEN-2:MW−1] is selected as the cin at index E+MW−1. The range [MW−1, MXLEN−2] and index E+MW−1 is used in this case as the carry-out from index E+MW−1 is the carry-in at index E+MW.

The consideration for the hardware or software entity for evaluation Eq. (20) respective (21) are similar to the hardware or software entity for evaluation Eq. (18) respective (19), mutatis mutandis.

It is noted that for E>(CAP_MAX_E−3), the index E+MW respective E+MW−1 lies outside the range [MW, MXLEN−1] respective [MW−1, MXLEN−2]. This is a consequence of the observation that for a large exponent Eq. (11) is satisfied. Consequently, for this value of E, cin does not need to be solved.

In one aspect of the invention, the determination of whether delta[MXLEN−1:E+MW] is suitably sign extended is performed if the expression E+MW<MXLEN is satisfied. In another aspect of the invention, the exponent E, or equivalently the expression E+MW≥MXLEN, is evaluated before determining whether delta[MXLEN−1:E+MW] is suitably sign extended. In this aspect, the evaluation is tested in decision block 112. If the decision block 112 indicates that the exponent E is a large exponent, Eq. (1) is satisfied, the representable verification succeeds and any further evaluation of Eq. (11) is unnecessary. The success of the representable verification is indicated by propagating the capability verification tag by block 114. Block 114 thus represents the hardware entity setting the verification tag as specified by the CHERI RISC-V standard. If the decision block 112 indicates that the exponent E is not a large exponent, then evaluation of Eq. (11) proceeds as disclosed supra.

Referring back to evaluating the cin, block 130 may compute the cin by directly evaluating Eq. (8), which is computationally expensive because it typically requires a truncation of delta[MXLEN−1:0] and oldAddr[MXLEN−1:0] to evaluate delta[E+MW−1:0] and oldAddr[E+MW−1:0], followed by an adder and a right shift. As understood by a person of ordinary skill in the art, the result of such operations may be performed by multiple structures, examples of which are given infra.

In one aspect of the invention, block 130 computes the cin by detecting the carry in by separate an array of 49 adders for a 64-bit system, due to the fact that the E+MW-1 value is variable, nothing that for E>49 the expression evaluates to a large exponent. Such an array would comprise a different adder for each of the different value of E:

$$old Addr [ MW - 1 : 0 ] + delta [ MW - 1 : 0 ] ;$$

$$old Addr [ 1 + MW - 1 : 0 ] + delta [ 1 + MW - 1 : 0 ] ;$$

$$… ;$$

$$old Addr [ 49 + MW - 1 : 0 ] + delta [ 49 + MW - 1 : 0 ] .$$

and then the carry out from each of the 49 adders are provided into a 49-way multiplexer. The 49-way multiplexer then selects the carry out to be used as cin based on the value of E, which can have a value from 0 to CAP_MAX_E−3.

In yet another aspect of the invention, block 130 computes the cin by first modifying either one of the oldAddr[MXLEN−1:E+MW] and the delta[MXLEN−1:E+MW] by setting all the bits in the bit range [E+MW, MXLEN−1] to 1, and modifying the other one of the oldAddr[MXLEN−1:E+MW] or the delta[MXLEN−1:E+MW] by setting all the bits in the bit range [E+MW, MXLEN−1] to 0. Subsequently, block 130 sums the modified oldAddr[MXLEN−1:0] and the delta[MXLEN−1:0], and obtains the cin by using the logical negative of the result of the adder at index MXLEN−1. A person of ordinary skill in the art will also appreciate, that in this case, cin may also be obtained from taking the logical negative of the result of the adder at any index in the range [E+MW, MXLEN−1] or by extracting the carry-out from the sum performed by the block 130.

In yet another aspect of the invention, block 130 computes the cin by first modifying both the oldAddr[MXLEN−1:E+MW] and the delta[MXLEN−1:E+MW] by setting the bit at index [E+MW] to the same value, either 0 or 1. Subsequently, block 130 sums the modified oldAddr[MXLEN−1:0] and delta[MXLEN−1:0]. The cin is then determined as the result of the summation at index [E+MW].

In the cases where delta[MXLEN−1:0] has a known limited range as described in paragraphs [51]-[58] supra, the cin computation structure can be simplified further since the bits of delta[MXLEN−1:E+MW] will all have the same value, i.e., all the bits are 1s if delta[MXLEN−1:E+MW] is negative, or all the bits are 0s if delta[MXLEN−1:E+MW] is positive. Those of ordinary skill in the art will appreciate that this allows simplification in computing cin as it reduces the complexity of the adder due to the fact that in the restricted range of the operand delta[E+MW−1:N] in Eq. (8) is suitably sign extended.

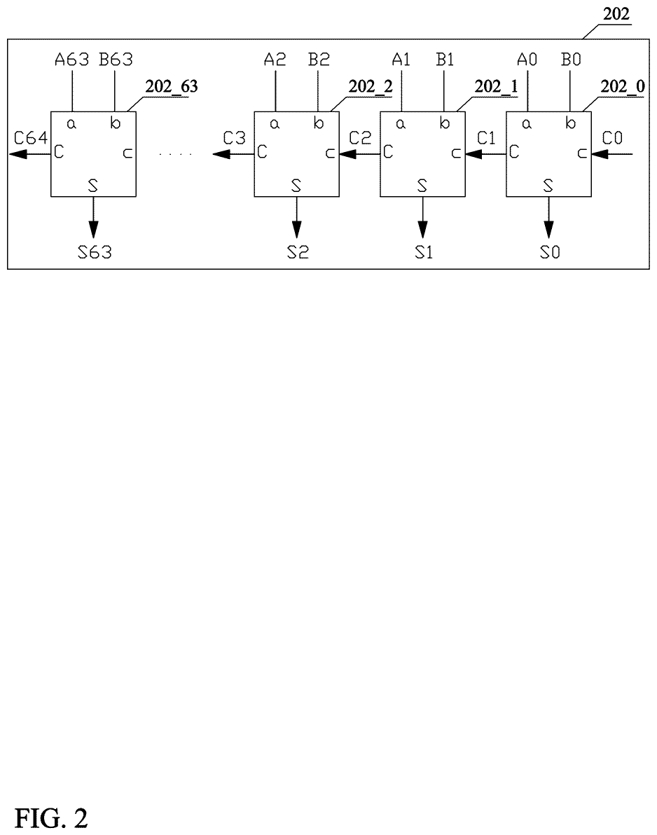

In another aspect of the invention, instead of solving Eq. (8), the calculation cin can be performed by a structure calculating oldAddr[MXLEN−1:0]+delta[MXLEN−1:0], which exposes the carry out bits from the range [MW, MXLEN−1]. By means of an example of a structure that exposes the carry out bits, consider FIG. 2 depicting a conceptual structure of a 64-bit serial adder 202, comprising full adders 202_0 through 202_63 that exposes all carry-in signals, i.e., C0 through C63. In a 64-bit system, the carry-ins C14 through C63 are provided into a 49-way multiplexer (not shown). The 49-way multiplexer then selects the carry out to be used as cin based on the value of E, which can have a value from 0 to CAP_MAX_E−3.

The structure of the serial adder in FIG. 2 is provided for an explanation of the concept of exposing the carry-in bits, however, being a serial adder would be too slow. Although adders utilizing parallel adder structures are computationally efficient, the efficiency is due to a complex, low delay logic, that hides at least some of the carry in signals, which are thus not exposed for further processing. Consequently, such a calculation can be carried out by a parallel adder structure with low delay logic that preserve the carry in from each bit position in at least the range [MW, MXLEN−1] or carry out in at least the range [MW−1, MXLEN−2] as disclosed supra. Comparing the required calculation with Eq. (8), should such a structure be computationally efficient, so that the calculation can be accomplished within a clock interval, the structure can replace the main ALU adder used to calculate newAddr[MXLEN−1:0]; otherwise, the structure needs to be embodied separately. In both cases the logic delay of such a structure may be faster than adding logic after the main adder to detect the carry-ins.

Regardless of the manner of computation of cin by block 130, in one aspect of the invention it is possible to solve Eq. (11) by direct calculation. Since cin is a binary number while delta[MXLEN−1:E+MW] and cfChange are signed binary numbers, an adder and a comparator for a two's complement signed arithmetic can efficiently solve Eq. (11). In fact, an adder and a comparator for any arithmetic accounting for signed binary numbers can be used. By means of an example, consider that an M-bit, M>1, adder and comparator are implemented. Any bit or a plurality of bits of delta[MXLEN−1:E+MW] may be used to produce the M-bit signal that represents delta[MXLEN−1:E+MW] 's contribution to the summation to solve Eq. (11). Similarly, cfChange and cin can be sign-extended into an M-bit signal.

In another aspect of the invention, it is possible to further improve the speed of evaluating Eq. (11) by constructing a look-up table from all the combinations of the values of cfChange, cin, and delta[MXLEN−1:E+MW]. As discussed supra, some of the combinations are logically impossible. However, in case of a hardware or a software failure, such combinations may occur. Consequently, in one aspect of the invention all the combinations are part of the look-up table as shown in Table 7, and should such a combination occur, the result will be tagged as impossible, indicating an error.

TABLE 7

| | | | | For Illustrative |
|---|---|---|---|---|
| At least one | | | | purposes only: |
| bit from delta | | | | delta [MXLEN-1: |
| [MXLEN-1: | | | Equation | E + MW] + |
| E + MW ] | cin | cfChange | satisfied? | cin + cfChange |
| 0 | 0 | 0 | Yes | 0 + 0 + 0 = 0 |
| −1 | 0 | 0 | No | −1 + 0 + 0 = −1 |
| 0 | 1 | 0 | No | 0 + 1 + 0 = 1 |
| −1 | 1 | 0 | Yes | −1 + 1 + 0 = 0 |
| 0 | 0 | 1 | No | 0 + 0 + 1 = 1 |
| −1 | 0 | 1 | Yes | −1 + 0 + 1 = 0 |
| 0 | 1 | 1 | IMPOSSIBLE! | |
| −1 | 1 | 1 | IMPOSSIBLE! | |
| 0 | 0 | −1 | IMPOSSIBLE! | |
| −1 | 0 | −1 | IMPOSSIBLE! | |
| 0 | 1 | −1 | Yes | 0 + 1−1 = 0 |
| −1 | 1 | −1 | No | −1 + 1−1 = −1 |
| 0 | 0 | 0 | Yes | 0 + 0 + 0-0 |
| −1 | 0 | 0 | No | −1 + 0 + 0 = −1 |
| 0 | 1 | 0 | No | 0 + 1 + 0 = 1 |
| −1 | 1 | 0 | Yes | −1 + 1 + 0 = 0 |

In another aspect of the invention, the combination of the values cfChange, cin, and delta[MXLEN−1:E+MW] is tested for the combinations that should not occur, before these values are looked-up in the look-up table, and should such a combination occur, the result will be tagged as impossible, indicating an error. Consequently, the look-up table does not contain the logically impossible combinations. In either case of detecting an error, the representable range verification can be declared as failure.

Furthermore, considering that delta[MXLEN−1:E+MW] is suitably sign extended, the entry to the table is at least one bit within the range [E+MW, MXLEN−1]. As disclosed in paragraph [50] supra, the value of delta[MXLEN−1:E+MW]=−1 in the table is represented by the at least one bit being 1(s) and, similarly, the value of delta[MXLEN−1:E+MW]=0 in the table is represented by the at least one bit being 0(s).

Additionally, considering Table 5, wherein cfChange can be expressed in terms of newALtR and oldALER, Table 7 can be reformulated as Table 8, an evaluation of which is computationally cheaper. The same consideration regarding the combination of the values to be included in or excluded from Table 8 as discussed in regard to Table 7 apply mutatis mutandis.

TABLE 8

| | | | At least one bit from | |
|---|---|---|---|---|
| | | | delta [MXLEN-1: | Equation |
| newALtR | oldALER | cin | E + MW] | satisfied? |
| 0 | 0 | 0 | 0 | Yes |
| 0 | 0 | 0 | −1 | No |
| 0 | 0 | 1 | 0 | No |
| 0 | 0 | 1 | −1 | Yes |
| 0 | 1 | 0 | 0 | No |
| 0 | 1 | 0 | −1 | Yes |
| 0 | 1 | 1 | 0 | IMPOSSIBLE! |
| 0 | 1 | 1 | −1 | IMPOSSIBLE! |
| 1 | 0 | 0 | 0 | IMPOSSIBLE! |
| 1 | 0 | 0 | −1 | IMPOSSIBLE! |
| 1 | 0 | 1 | 0 | Yes |
| 1 | 0 | 1 | −1 | No |
| 1 | 1 | 0 | 0 | Yes |
| 1 | 1 | 0 | −1 | No |
| 1 | 1 | 1 | 0 | No |
| 1 | 1 | 1 | −1 | Yes |

Eq (11) is evaluated in block 132 in accordance with the above-described principles, i.e., by direct evaluation of the Eq (11) or an indirect evaluation via either the Table 7 or Table 8. The output of the block 132 is tested in block 134. Should the result of the test indicate success, the processing continues in block 114 as described supra; otherwise, the processing continues in block 120 as described supra.

The various aspects of this disclosure are provided to enable a person having ordinary skill in the art to practice the present invention. Various modifications to these aspects will be readily apparent to persons of ordinary skill in the art, and the concepts disclosed therein may be applied to other aspects without departing from the spirit or scope of the invention. Thus, the present invention is not intended to be limited to the aspects shown herein but is to be accorded the widest scope consistent with the principles and novel features disclosed herein.

Therefore, a person having ordinary skill in the art will understand, that the flow chart is not exhaustive because certain steps may be added or be unnecessary and/or may be carried out in parallel based on a particular implementation. By means of an example, as disclosed supra, one of the purposes of block 118 is to determine, whether the instruction 102 is a specific instruction. Consequently, the function of block 118 maybe split, so that the determination whether the instruction 102 is a specific instruction may be performed at different steps of the processing, e.g., immediately upon fetching and starting processing the instruction 102, (not shown).

All structural and functional equivalents to the various illustrative logical blocks, modules, circuits, and algorithm steps described in connection with the various aspects described throughout this disclosure that are known or later come to be known to those of ordinary skill in the art are expressly incorporated herein by reference and are intended to be encompassed by the claims. Such illustrative logical blocks, modules, circuits, and algorithm steps may be implemented as electronic hardware, computer software, or combinations of both, provided that the implementation at the minimum satisfies the design criteria. By means of an example, should the fastest performance be desired, all the illustrative logical blocks, modules, and circuits should be implemented in hardware.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using the phrase “means for” or, in the case of a method claim, the element is recited using the phrase “step for.”

What is claimed is:

1. A method for an efficient representable range verification for a Capability Hardware Enhanced RISC Instructions (CHERI) enabled Central Processing Unit (CPU) comprising:
determining MXLEN, MW, and E;
determining a relationship between E, MXLEN, and MW;
determining whether a delta[MXLEN−1:E+MW] is suitably sign extended for the relationship E+MW<MXLEN;
responding to the delta[MXLEN−1:E+MW] being suitably sign extended:
determining a cfChange as a difference between a correction factor of the address of the source capability and a correction factor of the address of the destination capability;
determining a cin as a carry_in from a range [E+MW−1:0];
declaring the representable range verification success for an equation delta[MXLEN−1:E+MW]+cfChange+cin=0 being satisfied; and
declaring the representable range verification failure for the equation not being satisfied.

2. The method as claimed in claim 1, further comprising:
declaring the representable range verification failure for the delta[MXLEN−1:E+MW], not being suitably sign extended.

3. The method as claimed in claim 1, further comprising:
declaring the representable range verification success for the relationship E+MW≥MXLEN.

4. The method as claimed in claim 1, wherein the determining whether the delta[MXLEN−1:E+MW] is suitably sign extended comprises:
determining a delta[MXLEN−1:0]; and
declaring the delta[MXLEN−1:E+MW] being suitably sign extended for the determined value of delta[MXLEN−1:0] being within a range [−2^{N}, +2^{N}−1], wherein:
a maximum value of N is a number of bits in delta[E+MW−1:0]−1, and E+MW>N.

5. The method as claimed in claim 4, wherein the determining the delta[MXLEN−1:0] comprises:
requesting one or more parameters;
adjusting a range of each of the one or more parameters to [MXLEN−1:0]; and
setting the delta[MXLEN−1:0] equal to the one adjusted parameter or to a combination of the more than the one adjusted parameter.

6. The method as claimed in claim 4, wherein the determining the delta[MXLEN−1:0] comprises:
receiving an address of a source capability (oldAddr[MXLEN−1:0]) and an address of a destination capability (newAddr[MXLEN−1:0]);
calculating the delta[MXLEN−1:0] by subtracting the oldAddr[MXLEN−1:0] from the newAddr[MXLEN−1:0].

7. The method as claimed in claim 1, wherein the determining whether the delta[MXLEN−1:E+MW] is suitably sign extended comprises:
declaring the delta[MXLEN−1:E+MW] generated by specific instructions C.ADDI4SPN or C.ADDI16SP for any MXLEN or a specific instructions CADDI for MXLEN=64 being suitably sign extended.

8. The method as claimed in claim 1, wherein the determining whether the delta[MXLEN−1:E+MW] is suitably sign extended comprises:
declaring the delta[MXLEN−1:E+MW] generated by a specific instruction CADDI for MXLEN=32 is suitably extended for any of the conditions:
E>1;
E=1 and two most significant bits (MSBs) of a delta[11:0] being the same; and
E=0 and three MSBs of the delta[11:0] being the same.

9. The method as claimed in claim 1, wherein the determining the cfChange as the difference between the correction factor of the address of the source capability and the correction factor of the address of the destination capability comprises:
subtracting the correction factor of the address of the source capability from the correction factor of the address of the destination capability.

10. The method as claimed in claim 1, wherein the determining the cin comprises:
evaluating for each index in at least a range [MW, MXLEN−1] an equation carry_in[MXLEN−1:MW]=newAddr[MXLEN−1:MW] XOR oldAddr[MXLEN−1:MW] XOR delta[MXLEN−1:MW]; and
selecting the cin as the carry_in[MXLEN−1:MW] at an index E+MW.

11. The method as claimed in claim 1, wherein the determining the cin comprises:
evaluating an equation cin=carry_in[E+MW]=newAddr[E+MW] XOR oldAddr[E+MW] XOR delta[E+MW].

12. The method as claimed in claim 1, wherein the determining the cin comprises:
evaluating for each index in at least a range [MW−1, MXLEN−2] an equation carry_out[MXLEN−2:MW−1]=((oldAddr[MXLEN−2:MW−1] XOR delta[MXLEN−2:MW−1]) AND NOT (newAddr[MXLEN−2:MW−1])) OR (oldAddr[MXLEN−2:MW−1] AND delta[MXLEN−2:MW−1]); and
selecting the cin as the carry_out[MXLEN−2:MW−1] at an index E+MW−1.

13. The method as claimed in claim 1, wherein the determining the cin comprises:
evaluating an equation cin=carry_out[E+MW−1]=((oldAddr[E+MW−1] XOR delta[E+MW−1]) AND NOT (newAddr[E+MW-1])) OR (oldAddr[E+MW−1] AND delta[E+MW−1]).

14. The method as claimed in claim 1, wherein the evaluating whether the equation delta[MXLEN−1:E+MW]+cfChange+cin=0 is satisfied comprises:
substituting the delta[MXLEN−1:E+MW], the cfChange, and the cin into the equation.

15. The method as claimed in claim 1, wherein the evaluating whether the equation delta[MXLEN−1:E+MW]+cin+cfChange=0 is satisfied comprises:
constructing a look-up table of at least logically possible combinations of all combinations of the cfChange, the cin, and the delta[MXLEN−1:E+MW], and a result of the at least the logically possible combinations, wherein the delta[MXLEN−1:E+MW] is represented by at least one bit from a range [MXLEN−1:E+MW];
determining whether the equation delta[MXLEN−1:E+MW]+cin+cfChange=0 is satisfied from the look-up table's result corresponding to the determined cfChange, cin, and delta[MXLEN−1:E+MW].

16. The method as claimed in claim 15, wherein the look-up table of the at least the logically possible combinations of all the combinations of the cfChange, the cin, the delta[MXLEN−1:E+MW], and the result of the at least the logically possible combinations comprise:

| At least one bit from | | | |
|---|---|---|---|
| delta[MXLEN-1: | | | Equation |
| E + MW] | cin | cfChange | satisfied? |
| 0 | 0 | 0 | Yes |
| −1 | 0 | 0 | No |
| 0 | 1 | 0 | No |
| −1 | 1 | 0 | Yes |
| 0 | 0 | 1 | No |
| −1 | 0 | 1 | Yes |
| 0 | 1 | 1 | IMPOSSIBLE! |
| −1 | 1 | 1 | IMPOSSIBLE! |
| 0 | 0 | −1 | IMPOSSIBLE! |
| −1 | 0 | −1 | IMPOSSIBLE! |
| 0 | 1 | −1 | Yes |
| −1 | 1 | −1 | No |
| 0 | 0 | 0 | Yes |
| −1 | 0 | 0 | No |
| 0 | 1 | 0 | No |
| −1 | 1 | 0 | Yes |

17. The method as claimed in claim 15, wherein the look-up table of the at least the logically possible combinations of all the combinations of the cfChange, the cin, the delta[MXLEN−1:E+MW], and the result of the at least the logically possible combinations comprise:

| At least one bit from | | | |
|---|---|---|---|
| delta[MXLEN-1: | | | Equation |
| E + MW] | cin | cfChange | satisfied? |
| 0 | 0 | 0 | Yes |
| −1 | 0 | 0 | No |
| 0 | 1 | 0 | No |
| −1 | 1 | 0 | Yes |
| 0 | 0 | 1 | No |
| −1 | 0 | 1 | Yes |
| 0 | 1 | −1 | Yes |
| −1 | 1 | −1 | No |
| 0 | 0 | 0 | Yes |
| −1 | 0 | 0 | No |
| 0 | 1 | 0 | No |
| −1 | 1 | 0 | Yes |

18. The method as claimed in claim 1, wherein the evaluating whether the equation delta[MXLEN−1:E+MW]+cin+cfChange=0 is satisfied comprises:
constructing a look-up table of at least logically possible combinations of all combinations of values of the destination capability address window (newAltR), the source capability address window (oldAltR), the cin, the delta[MXLEN−1:E+MW], and the result of the at least the logically possible combinations, wherein the delta[MXLEN−1:E+MW] is represented by at least one bit from the range [MXLEN−1:E+MW];
determining whether the equation delta[MXLEN−1:E+MW]+cin+cfChange=0 is satisfied from the look-up table's result corresponding to the determined values of the newAltR, the oldAltR, the cin, and the delta[MXLEN−1:E+MW].

19. The method as claimed in claim 18, wherein the look-up table of the at least the logically possible combinations of all the combinations of the values of the newAltR, the oldAltR, the cin, and the delta[MXLEN−1:E+MW] comprise:

| | | | At least one bit from | Equation |
|---|---|---|---|---|
| | | | delta [MXLEN-1: | |
| newAltR | oldAltR | cin | E + MW] | satisfied? |
| 0 | 0 | 0 | 0 | Yes |
| 0 | 0 | 0 | −1 | No |
| 0 | 0 | 1 | 0 | No |
| 0 | 0 | 1 | −1 | Yes |
| 0 | 1 | 0 | 0 | No |
| 0 | 1 | 0 | −1 | Yes |
| 0 | 1 | 1 | 0 | IMPOSSIBLE! |
| 0 | 1 | 1 | −1 | IMPOSSIBLE! |
| 1 | 0 | 0 | 0 | IMPOSSIBLE! |
| 1 | 0 | 0 | −1 | IMPOSSIBLE! |
| 1 | 0 | 1 | 0 | Yes |
| 1 | 0 | 1 | −1 | No |
| 1 | 1 | 0 | 0 | Yes |
| 1 | 1 | 0 | −1 | No |
| 1 | 1 | 1 | 0 | No |
| 1 | 1 | 1 | −1 | Yes |

20. The method as claimed in claim 18, wherein the look-up table of the at least the logically possible combinations of all the combinations of the values of the newAltR, the oldAltR, the cin, and the delta[MXLEN−1:E+MW] comprises:

| | | | At least one bit from | |
|---|---|---|---|---|
| | | | delta [MXLEN-1: | Equation |
| newALER | oldALER | cin | E + MW] | satisfied? |
| 0 | 0 | 0 | 0 | Yes |
| 0 | 0 | 0 | −1 | No |
| 0 | 0 | 1 | 0 | No |
| 0 | 0 | 1 | −1 | Yes |
| 0 | 1 | 0 | 0 | No |
| 0 | 1 | 0 | −1 | Yes |
| 1 | 0 | 1 | 0 | Yes |
| 1 | 0 | 1 | −1 | No |
| 1 | 1 | 0 | 0 | Yes |
| 1 | 1 | 0 | −1 | No |
| 1 | 1 | 1 | 0 | No |
| 1 | 1 | 1 | −1 | Yes |

21. The method as claimed in claim 1, wherein the determining the relationship between E, MXLEN, and MW comprises:
evaluating an equation E> (CAP_MAX_E−3), wherein CAP_MAX_E is maximum legal value for the E;
declaring E to be the large exponent if the equation is satisfied; and
declaring the delta[MXLEN−1:E+MW] to be suitably sign extended for E not being a large exponent.

22. An apparatus for an efficient representable range verification for a Capability Hardware Enhanced RISC Instructions (CHERI) enabled Central Processing Unit (CPU) comprising:
means for determining MXLEN, MW, and E;
means for determining a relationship between E, MXLEN, and MW;
means for determining whether a delta[MXLEN−1:E+MW] is suitably sign extended for the relationship E+MW<MXLEN;
in response to the delta[MXLEN−1:E+MW] being suitably sign extended:
means for determining a cfChange as a difference between a correction factor of the address of the source capability and a correction factor of the address of the destination capability;
means for determining a cin as a carry in from the range [E+MW−1:0];
means for declaring the representable range verification success for an equation delta[MXLEN−1:E+MW]+cfChange+cin=0 being satisfied; and
means for declaring the representable range verification failure for the equation not being satisfied.

23. The apparatus as claimed in claim 22, further comprising:
means for declaring the representable range verification failure for the delta[MXLEN−1:E+MW], not being suitably sign extended.

24. The apparatus as claimed in claim 22, further comprising:
means for declaring the representable range verification success for the relation E+MW≥MXLEN.

25. The apparatus as claimed in claim 22, wherein the means for determining whether the delta[MXLEN−1:E+MW] is suitably sign extended comprises:
means for determining a delta[MXLEN−1:0]; and
means for declaring the delta[MXLEN−1:E+MW] being suitably sign extended for the determined delta[MXLEN−1:0] being within a range [−2^{N}, +2^{N}−1], wherein:
a maximum value of N is a number of bits in a delta[E+MW−1:0]−1 bit, and E+MW>N.

26. The apparatus as claimed in claim 25, wherein the means for determining the delta[MXLEN−1:0] comprises:
a Central Processing Unit (CPU) configured to request one or more parameters;
means for adjusting a range of each of the one or more parameters to [MXLEN−1:0]; and
means for setting the delta[MXLEN−1:0] equal to the one adjusted parameter or to a combination of the more than the one adjusted parameter.

27. The apparatus as claimed in claim 25, wherein the means for determining the delta[MXLEN−1:0] comprises:
a CPU configured to request an address of a source capability (oldAddr[MXLEN−1:0]) and an address of a destination capability (newAddr[MXLEN−1:0]);
means for calculating delta[MXLEN−1:0] by subtracting the oldAddr[MXLEN−1:0] from the newAddr[MXLEN−1:0].

28. The apparatus as claimed in claim 22, wherein the means for determining whether the delta[MXLEN−1:E+MW] is suitably sign extended comprises:
means for declaring the delta[MXLEN−1:E+MW] generated by specific instructions C.ADDI4SPN or C.ADDI16SP for any MXLEN or a specific instructions CADDI for MXLEN=64 being suitably sign extended.

29. The apparatus as claimed in claim 22, wherein the means for determining whether the delta[MXLEN−1:E+MW] is suitably sign extended comprises:
means for declaring the delta[MXLEN−1:E+MW] generated by a specific instruction CADDI for MXLEN=32 is suitably extended for any of the conditions:
E>1;
E=1 and two most significant bits (MSBs) of a delta[11:0] being the same; and
E=0 and three MSBs of the delta[11:0] being the same.

30. The apparatus as claimed in claim 22, wherein the means for determining the cfChange as the difference between the correction factor of the address of the source capability and the correction factor of the address of the destination capability comprises:
means for subtracting the correction factor of the address of the source capability from the correction factor of the address of the destination capability.

31. The apparatus as claimed in claim 22, wherein the means for determining the cin comprises:
means for evaluating for each index in at least a range [MW, MXLEN−1] an equation carry_in[MXLEN−1:MW]=newAddr[MXLEN−1:MW] XOR oldAddr[MXLEN−1:MW] XOR delta[MXLEN−1:MW]; and
means for selecting the cin as the carry_in[MXLEN−1:MW] at an index E+MW.

32. The apparatus as claimed in claim 22, wherein the means for determining the cin comprises:
means for evaluating an equation cin=carry_in[E+MW]=newAddr[E+MW] XOR oldAddr[E+MW] XOR delta[E+MW].

33. The apparatus as claimed in claim 22, wherein the means for determining the cin comprises:
means for evaluating for each index in at least a range [MW−1, MXLEN−2] an equation carry_out[MXLEN−2:MW−1]=((oldAddr[MXLEN−2:MW−1] XOR delta[MXLEN−2:MW−1]) AND NOT (newAddr[MXLEN−2:MW-1])) OR (oldAddr[MXLEN−2:MW−1] AND delta[MXLEN−2:MW−1]); and
means for selecting the cin as the carry_out[MXLEN−2:MW−1] at an index E+MW−1.

34. The apparatus as claimed in claim 22, wherein the means for determining the cin comprises:
means for evaluating an equation cin=carry_out[E+MW−1]=((oldAddr[E+MW−1] XOR delta[E+MW−1]) AND NOT (newAddr[E+MW-1])) OR (oldAddr[E+MW−1] AND delta[E+MW−1]).

35. The apparatus as claimed in claim 22, wherein the means for evaluating whether the equation delta[MXLEN−1:E+MW]+cfChange+cin=0 is satisfied comprises:
means for evaluating the equation by substituting the delta[MXLEN−1:E+MW], the cfChange, and the cin into the equation.

36. The apparatus as claimed in claim 22, wherein the means for evaluating whether the equation delta[MXLEN−1:E+MW]+cin+cfChange=0 is satisfied comprises:
a look-up table of at least logically possible combinations of all combinations of the cfChange, the cin, and the delta[MXLEN−1:E+MW], and a result of the at least the logically possible combinations, wherein the delta[MXLEN−1:E+MW] is represented by at least one bit from a range [MXLEN−1:E+MW];
means for determining whether the equation delta[MXLEN−1:E+MW]+cin+cfChange=0 is satisfied from the look-up table's result corresponding to the determined cfChange, cin, and delta[MXLEN−1:E+MW].

37. The apparatus as claimed in claim 36, wherein the look-up table of the at least the logically possible combinations of all the combinations of the cfChange, the cin, the delta[MXLEN−1:E+MW], and the result of the at least the logically possible combinations comprise:

| At least one bit from | | | |
|---|---|---|---|
| delta [MXLEN-1: | | | Equation |
| E + MW] | cin | cfChange | satisfied? |
| 0 | 0 | 0 | Yes |
| −1 | 0 | 0 | No |
| 0 | 1 | 0 | No |
| −1 | 1 | 0 | Yes |
| 0 | 0 | 1 | No |
| −1 | 0 | 1 | Yes |
| 0 | 1 | 1 | IMPOSSIBLE! |
| −1 | 1 | 1 | IMPOSSIBLE! |
| 0 | 0 | −1 | IMPOSSIBLE! |
| −1 | 0 | −1 | IMPOSSIBLE! |
| 0 | 1 | −1 | Yes |
| −1 | 1 | −1 | No |
| 0 | 0 | 0 | Yes |
| −1 | 0 | 0 | No |
| 0 | 1 | 0 | No |
| −1 | 1 | 0 | Yes |

38. The apparatus as claimed in claim 36, wherein the look-up table of the at least the logically possible combinations of all the combinations of all the combinations of the cfChange, the cin, the delta[MXLEN−1:E+MW], and the result of the at least the logically possible combinations comprise:

| At least one bit from | | | |
|---|---|---|---|
| delta[MXLEN-1: | | | Equation |
| E + MW] | cin | cfChange | satisfied? |
| 0 | 0 | 0 | Yes |
| −1 | 0 | 0 | No |
| 0 | 1 | 0 | No |
| −1 | 1 | 0 | Yes |
| 0 | 0 | 1 | No |
| −1 | 0 | 1 | Yes |
| 0 | 1 | −1 | Yes |
| −1 | 1 | −1 | No |
| 0 | 0 | 0 | Yes |
| −1 | 0 | 0 | No |
| 0 | 1 | 0 | No |
| −1 | 1 | 0 | Yes |

39. The apparatus as claimed in claim 22, wherein the means for evaluating whether the equation delta[MXLEN−1:E+MW]+cin+cfChange=0 is satisfied comprises:
a look-up table of at least the possible combinations of all the combinations of the value of the destination capability address window (newAltR), the value of the source capability address window (oldAltR), the cin, delta[MXLEN−1:E+MW], and the result of the combinations, wherein the value of delta[MXLEN−1:E+MW] is represented by at least one bit from the range [MXLEN−1:E+MW];
means for determining whether the equation delta[MXLEN−1:E+MW]+cin+cfChange=0 is satisfied from a look-up table result corresponding to the determined values of the newAltR, the value of the oldAltR, the cin, and the delta[MXLEN−1:E+MW].

40. The apparatus as claimed in claim 39, wherein the look-up table of the at least the possible combinations of all the combinations of the values of the newAltR, the oldAltR, the cin, and the delta[MXLEN−1:E+MW] comprises:

| | | | At least one bit from | |
|---|---|---|---|---|
| | | | delta [MXLEN-1: | Equation |
| newAltR | oldAltR | cin | E + MW] | satisfied? |
| 0 | 0 | 0 | 0 | Yes |
| 0 | 0 | 0 | −1 | No |
| 0 | 0 | 1 | 0 | No |
| 0 | 0 | 1 | −1 | Yes |
| 0 | 1 | 0 | 0 | No |
| 0 | 1 | 0 | −1 | Yes |
| 0 | 1 | 1 | 0 | IMPOSSIBLE! |
| 0 | 1 | 1 | −1 | IMPOSSIBLE! |
| 1 | 0 | 0 | 0 | IMPOSSIBLE! |
| 1 | 0 | 0 | −1 | IMPOSSIBLE! |
| 1 | 0 | 1 | 0 | Yes |
| 1 | 0 | 1 | −1 | No |
| 1 | 1 | 0 | 0 | Yes |
| 1 | 1 | 0 | −1 | No |
| 1 | 1 | 1 | 0 | No |
| 1 | 1 | 1 | −1 | Yes |

41. The apparatus as claimed in claim 39, wherein the look-up table of the at least the possible combinations of all the combinations of the values of the newAltR, the oldAltR, the cin, and the delta[MXLEN−1:E+MW] comprises:

| | | | At least one bit from | |
|---|---|---|---|---|
| | | | delta[XLEN-1: | Equation |
| newALER | oldALER | cin | E + MW] | satisfied? |
| 0 | 0 | 0 | 0 | Yes |
| 0 | 0 | 0 | −1 | No |
| 0 | 0 | 1 | 0 | No |
| 0 | 0 | 1 | −1 | Yes |
| 0 | 1 | 0 | 0 | No |
| 0 | 1 | 0 | −1 | Yes |
| 1 | 0 | 1 | 0 | Yes |
| 1 | 0 | 1 | −1 | No |
| 1 | 1 | 0 | 0 | Yes |
| 1 | 1 | 0 | −1 | No |
| 1 | 1 | 1 | 0 | No |
| 1 | 1 | 1 | −1 | Yes |

42. The apparatus as claimed in claim 22, wherein the means for determining the relation between E, MXLEN, and MW comprises:
means for evaluating an equation E>(CAP_MAX_E−3), wherein CAP_MAX_E is maximum legal value for the E;
means for declaring E to be the large exponent if the equation is satisfied; and
means for declaring delta[MXLEN−1:E+MW] to be suitably sign extended for E not being a large exponent.
